(19) United States
(12) Patent Application Publication
(10) Pub. No.: US 2025/0176551 A1
(43) Pub. Date: Jun. 5, 2025

(54) METHOD FOR CONTROLLING THE GROWTH OF UNDESIRABLE VEGETATION

(71) Applicant: UPL Limited, Mumbai (IN)

(72) Inventors: Giuvan Lenz, Pereiras (BR); Ganesh Rao, Mumbai (IN)

(21) Appl. No.: 18/800,855

(22) Filed: Aug. 12, 2024

Related U.S. Application Data
(63) Continuation of application No. 18/433,701, filed on Feb. 6, 2024, now abandoned.
Application No. 18/433,701 is a division of application No. 17/691,346, filed on Mar. 10, 2022, now abandoned.
(63) Continuation of application No. 17/691,343, filed on Mar. 10, 2022, now abandoned.
(63) Continuation of application No. 17/691,207, filed on Mar. 10, 2022, now abandoned.
(63) Continuation of application No. 17/691,217, filed on Mar. 10, 2022, now abandoned.

(30) Foreign Application Priority Data
Oct. 7, 2021 (IN) 202121045719
Oct. 11, 2021 (IN) 202121046312
Oct. 11, 2021 (IN) 202121046316
Oct. 11, 2021 (IN) 202121046318

(51) Int. Cl. A01N 57/20; A01N 43/54; A01N 43/64

(52) U.S. Cl. CPC A01N 57/20; A01N 43/54; A01N 43/64

(57) ABSTRACT

Methods are described for controlling growth of undesirable vegetation at a locus by treating the locus with a synergistic combination comprising glufosinate and at least one herbicide selected from nitrophenyl ether class herbicides; imidazolinone class herbicides; organophosphorous class herbicides; dicarboximide class herbicides; phenoxyacetic class herbicides; pyridine class herbicides; cyclohexene oxime class herbicides; aryloxyphenoxypropionic class herbicides; triazolone class herbicides, uracil class herbicides, and combinations thereof, wherein the undesirable vegetation is selected from group consisting of Spermacoce latifolia, Brachiaria decumbens, Eleusine indica, Glycine max.

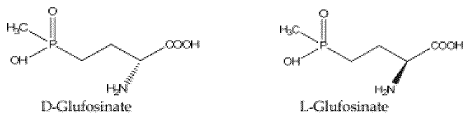

### CROSS-REFERENCE TO RELATED APPLICATIONS

This application is a continuation application of U.S. patent application Ser. No. 18/433,701, which is a Divisional application of Ser. No. 17/691,346, now abandoned, which claims priority to Indian Patent Application No. 202121046316 filed on Oct. 11, 2021; U.S. patent application Ser. No. 17/691,343, which claims priority to Indian Patent Application No. 202121046318 filed on Oct. 11, 2021; U.S. patent application Ser. No. 17/691,207, which claims priority to Indian Patent Application No. 202121045719 filed Oct. 7, 2021; and U.S. patent application Ser. No. 17/691,217, which claims priority to Indian Patent Spplication No. 202121046312 filed Oct. 11, 2021, all of which are incorporated herein by reference in its entirety.

### FIELD OF THE INVENTION

The present invention relates to a method of controlling the growth of undesirable vegetation. More particularly, the present invention relates to a method of controlling the growth of weeds selected from Spermacoce latifolia, Brachiaria decumbens, Eleusine indica, Glycine max, with a synergistic combination/composition.

### BACKGROUND OF THE INVENTION

Weeds are undesirable plants that are detrimental to agriculture and significantly affect crop yields. Farmers use various types of herbicides to control weeds. Herbicides with varied modes of action are generally combined, which allows for broader spectrum of control and managing resistance to herbicides.

Spermacoce latifolia, also known as Borreria latifolia, is a major weed across the Americas, South Asian and South East Asian countries. It is a prolific seeder, is fast growing and becomes reproductive within 2 months. Given its aggressive colonization, prompt consideration should be given to controlling the spread of S. latifolia. However, the herbicide combinations currently known are not sufficient to control resistant and persistent weeds such as Spermacoce latifolia.

It is reported that, in areas infested with Brachiaria decumbens, there may be up to 82% yield reduction in crops. Brachiaria decumbens is a perennial plant, much tillered, upright and 30-100 cm tall. Its reproduction occurs through seeds, rhizomes and stolons. Its seeds can present viability for up to 8 years; the majority present initial dormancy and can germinate at several depths (0-8 cm). This species presents difficult control of its sowing, due to the irregular and prolonged germination. As a consequence of this characteristic, its control in pre-emergence requires a herbicide with long effective period of (residual) control. In such cases, an effective herbicidal combination may hold some promise for good control over this weed.

Soybean is a widely cultivated food crop across the globe. Currently, there are about 24 species in the genus Glycine, only two of which (G. max and G. soja) are annuals. Soybean plants that have been genetically engineered to be resistant to the herbicides 2,4-D, glufosinate, and glyphosate generally grow as volunteer soybean in cultivation of various other crops such as corn, cotton, etc. Volunteer crop plants, in general, are considered to be weeds because they can reduce crop yield and quality and reduce harvesting efficiency. If glyphosate-resistant volunteer soybean populations are high and left uncontrolled, they may cause yield loss in crops. Volunteer soybeans serve as a reservoir for plant pathogens to survive between cropping seasons and increase inoculum of soil borne pathogens. Growers must apply alternate or additional non-glyphosate herbicides to achieve effective control of volunteer glyphosate-resistant soybean plants in glyphosate-resistant corn fields and in glyphosate-resistant cotton fields. However, the combinations currently known are not sufficient to control the resistant and persistent weeds such as Glycine max.

Eleusine indica, also known as the Indian goosegrass, yard-grass, goosegrass, wiregrass, or crowfoot grass, is a species of grass in the family Poaceae. It has a wide distribution due to the species' wide ecological amplitude. This plant loves light and is a weed problem mainly in crops grown in the warm and wet regions of the world. It is considered a “serious weed” in at least 42 countries. However, the herbicide combinations currently known are not sufficient to control the resistant and persistent weeds such as Eleusine indica .

Additionally, the combination of herbicides may not always result in the desired effect. Combinations of herbicides may result in an additive effect or an antagonistic effect. It may also result in phytotoxicity to the crops making it an undesirable combination. Consequently, herbicides need to be carefully selected so that they can be combined to offer a synergistic effect that would control weeds while having no phytotoxic effect on the crop and reduce the chances of the weeds developing resistance to a particular herbicide.

Accordingly, there is, therefore, a need in the art for a method for protecting crops from weeds using combinations that have advantageous properties such as a herbicidal combination that is synergistic, helps in resistance management, reduces dosage of herbicides used and a herbicidal combination that has excellent residual effects.

### OBJECTIVE OF THE INVENTION

It is an objective of the present invention to provide a method of controlling weeds selected from Spermacoce latifolia, Brachiaria decumbens, Eleusine indica, Glycine max, by application of a synergistic herbicidal combination.

It is an objective of the present invention to provide a method of controlling weeds selected from Spermacoce latifolia, Brachiaria decumbens, Eleusine indica, Glycine max, by application of a synergistic herbicidal combination comprising Glufosinate and at least one herbicide selected from nitrophenyl ether, imidazolinone, organophosphorous, dicarboximide, phenoxyacetic, pyridine, cyclohexene oxime, aryloxyphenoxypropionic, triazolone class of herbicides and/or uracil class of herbicides.

It is an objective of the present invention to provide a method of controlling weeds selected from Spermacoce latifolia, Brachiaria decumbens, Eleusine indica, Glycine max, by application of a synergistic herbicidal combination comprising Glufosinate and at least two herbicides selected from nitrophenyl ether, imidazolinone, organophosphorous, dicarboximide, phenoxyacetic, pyridine, cyclohexene oxime, aryloxyphenoxypropionic, triazolone class of herbicides, and/or uracil class of herbicides.

It is an objective of the present invention to provide a method of controlling weeds selected from Spermacoce latifolia, Brachiaria decumbens, Eleusine indica, Glycine max, in crop plants.

It is an objective of the present invention to provide a method of increasing yield in a crop by application of a synergistic herbicidal combination.

It is an objective of the present invention to provide a method of improving the plant health by application of a synergistic herbicidal combination.

### SUMMARY OF THE INVENTION

In an aspect, the present invention provides a method of controlling the growth of undesirable vegetation—weeds selected from Spermacoce latifolia, Brachiaria decumbens, Eleusine indica, Glycine max, the method comprising treating the locus at which control is desired with a synergistic composition comprising Glufosinate, and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides, and/or
j. uracil class of herbicides.

In another aspect, the present invention provides a synergistic composition for control of weeds selected from Spermacoce latifolia, Brachiaria decumbens, Eleusine indica, Glycine max, the composition comprising Glufosinate, and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides; and/or
j. uracil class of herbicides.

In a preferred embodiment, the glufosinate is L-glufosinate.

In accordance with another aspect, the weight ratio of the composition comprising Glufosinate and the second herbicide ranges from 1:100 to 100:1.

In accordance with another aspect, the weight ratio of the composition comprising Glufosinate and the second herbicide ranges from 1:75 to 75:1.

In accordance with another aspect, there is provided a method of controlling the growth of undesirable vegetation weeds selected from Spermacoce latifolia, Brachiaria decumbens, Eleusine indica, Glycine max, the method comprising treating the locus at which control is desired with a synergistic composition comprising Glufosinate, a herbicide selected from the imidazolinone class of herbicides, and a herbicide selected from the triazolone class of herbicides.

In accordance with yet another aspect, the weeds selected from Spermacoce latifolia, Brachiaria decumbens, Eleusine indica, Glycine max are controlled in a range of crops.

### BRIEF DESCRIPTION OF DRAWINGS

The Figure depicts the D-and L-isomers of glufosinate.

### DETAILED DESCRIPTION OF THE INVENTION

Discussed below are some representative embodiments of the present invention. The invention in its broader aspects is not limited to the specific details and representative methods. Illustrative examples are described in this section in connection with the embodiments and methods provided.

It is to be noted that, as used in the specification, the singular forms “a,” “an,” and “the” include plural referents unless the context clearly dictates otherwise. Thus, for example, reference to a composition containing “a surfactant” includes a mixture of two or more surfactants. It should also be noted that the term “'or” is generally employed in its sense including “and/or” unless the content clearly dictates otherwise. The terms “emulsifier” and “surfactant” mean essentially the same thing and may be used interchangeably. Further, the terms “composition” or “formulation” also mean essentially the same thing and may be used interchangeably.

The expression of various quantities in terms of “%” or “% w/w” means the percentage by weight of the total solution or composition unless otherwise specified. The present invention, in all its aspects, is described in detail as follows:

Glufosinate (phosphinothricin; DL-homoalanin-4-yl(methyl)phosphinic acid) is a racemic phosphinico amino acid (Hoerlein, G. 1994; Glufosinate (Phosphinothricin), a natural amino acid with unexpected herbicidal properties. Rev. of Environmental Contamination and Toxicology 138, 73-145). Its ammonium salt (glufosinate-ammonium) is widely used as a non-selective herbicide and is the active ingredient of the commercial herbicide formulations Basta™, Buster™, Challenge™ Conquest™, Dash™, Final™, Finale™, Liberty™ and Ignite™. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The D-isomer is not a GS inhibitor and is not herbicidally active as shown in the Figure.

It has surprisingly been found by the present inventors that weeds selected from Spermacoce latifolia, Brachiaria decumbens, Eleusine indica, Glycine max can be completely controlled by the combination of Glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides; and/or
j. uracil class of herbicides.

More surprisingly, it was found that this combination, between Glufosinate and the second herbicide, provided synergistic effect in controlling Spermacoce latifolia, Brachiaria decumbens, Eleusine indica, Glycine max. The degree of synergistic enhancement in efficacy of the above combination towards control of weeds selected from Spermacoce latifolia, Brachiaria decumbens, Eleusine indica, Glycine max was unpredictable and unexpected.

As used herein, the term “Glufosinate” refers to any molecule which is a racemic phosphinico amino acid or a salt thereof. The term also includes forms and isomers of glufosinate such as glufosinate-p, L-glufosinate, D-glufosinate, and sodium, potassium or ammonium salts thereof. The term can generically refer to any form of glufosinate or its salt such as solvates, hydrates, anhydrous form, polymorph forms, pseudo polymorph forms, amorphous form or mixture thereof.

Preferably, the herbicide glufosinate used in any aspect or embodiment described herein may be replaced by, or used interchangeably as, its L-isomer i.e. L-glufosinate.

As used herein, the term “L-glufosinate” refers to the L-isomer of glufosinate or a salt thereof. The L-isomer of glufosinate is a structural analogue of glutamate and, therefore, is a competitive inhibitor of the enzyme glutamine synthetase (GS) of bacteria and plants. The L-enantiomer of glufosinate acts by inhibition of glutamine synthetase thereby causing accumulation of toxic levels of ammonium ion and indirectly stopping photosynthesis. It is also known as phosphinothricin or(S)-2-amino-4-(hydroxy(methyl)phosphonoyl)butanoic acid. The term very commonly covers derivatives such as salts and esters of L-glufosinate. The term can generically refer to any form of L-glufosinate or its salt such as solvates, hydrates, anhydrous form, polymorph forms, pseudo polymorph forms, amorphous form or mixture thereof. The term “L-glufosinate or a salt thereof” encompasses any salt of L-glufosinate, preferable sodium, potassium and ammonium salts. The term may also refer to an isomeric (racemic) mixture of L-glufosinate, D-glufosinate and salts thereof, wherein the content of L-glufosinate or a salt thereof in the mixture is 70% or greater, preferably 80% or greater and more preferably 90% or greater.

Therefore, in an embodiment, the preferred glufosinate herbicide is L-glufosinate.

The term ‘Glycine max’ in the present scope of discussion refers to a soybean growing in fields wherein other crops are being grown. It may be referred to as volunteer soybean and comprises both wild-type or recombinant varieties of soybean. The term also includes resistant varieties of soybean to other herbicides, particularly resistant to the herbicides 2,4-D, glufosinate, and glyphosate. The resistant varieties may be naturally developed or genetically engineered to demonstrate the resistance phenotype.

The term ‘Spermacoce latifolia’ in the present scope of discussion refers to a weed growing in fields wherein other crops are being grown. That is, Spermacoce latifolia is a weed as it is not the target crop.

The term ‘herbicide’ as used herein denotes a compound which controls or modifies the growth of plants. The term ‘herbicidally effective amount’ indicates the quantity of such a compound or combination of such compounds which is capable of producing a controlling or modifying effect on the growth of plants. Controlling effects include all deviation from natural development, for example: killing, retardation, leaf burn, albinism, dwarfing etc. The term ‘plants’ refers to all physical parts of a plant, including seeds, seedlings, saplings, roots, tubers, stems, stalks, foliage and fruits. The ‘locus’ is intended to include soil, seeds, and seedlings as well as established vegetation.

The present invention, therefore, in an embodiment, provides a method of controlling the growth of undesirable vegetation at a locus, the method comprising treating the locus with a synergistic combination comprising Glufosinate, and at least one herbicide selected from: nitrophenyl ether class of herbicides;
a. imidazolinone class of herbicides;
b. organophosphorous class of herbicides;
c. dicarboximide class of herbicides;
d. phenoxyacetic class of herbicides;
e. pyridine class of herbicides;
f. cyclohexene oxime class of herbicides;
g. aryloxyphenoxypropionic class of herbicides;
h. triazolone class of herbicides;
i. uracil class of herbicides; or combinations thereof,
   wherein the undesirable vegetation is Spermacoce latifolia, Brachiaria decumbens, Eleusine indica, Glycine max.

In a preferred embodiment, glufosinate is L-glufosinate.

In an embodiment, the present invention provides a method of controlling the growth of undesirable vegetation at a locus, the method comprising treating the locus with a synergistic combination comprising L-Glufosinate, and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides; or combinations thereof,
   wherein the undesirable vegetation is Spermacoce latifolia, Brachiaria decumbens, Eleusine indica, Glycine max.

In an embodiment, nitrophenyl ether class herbicide is selected from the group consisting of oxyfluorfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, and combinations thereof.

In a preferred embodiment, the nitrophenyl ether class herbicide is oxyfluorfen.

In an embodiment, the imidazolinone class herbicide is selected from the group consisting of imazethapyr, imazamethabenz, imazamox, imazapic, imazapyr, imazaquin and combinations thereof.

In a preferred embodiment, the imidazolinone class herbicide is imazethapyr.

In an embodiment, the organophosphorous class of herbicide is selected from the group consisting of glyphosate, amiprofos-methyl, amiprophos, anilofos, bensulide, bilanafos, butamifos, clacyfos, 2,4-DEP, DMPA, EBEP, fosamine, glufosinate-P, huangcaoling, piperophos, shuangjiaancaolin and combinations thereof.

In a preferred embodiment, the organophosphorous class herbicide is glyphosate.

In an embodiment, the dicarboximide class herbicide is selected from the group consisting of flumioxazin, cinidon-ethyl, flumezin, flumiclorac, flumipropyn, and combinations thereof.

In a preferred embodiment, the dicarboximide class herbicide is flumioxazin.

In an embodiment, the phenoxyacetic class herbicide is selected from the group consisting of clacyfos, 2,4-D, 4-CPA (p-Chlorophenoxyacetic acid), 3,4-DA, MCPA (2-methyl-4-chlorophenoxyacetic acid), MCPA-thioethyl; 2,4,5-T, and combinations thereof.

In a preferred embodiment, the phenoxyacetic class herbicide is 2,4-D.

In an embodiment, pyridine class herbicide is selected from the group consisting of triclopyr, aminopyralid, cliodinate, clopyralid, diflufenican, dithiopyr, florpyrauxifen, flufenican, fluroxypyr, halauxifen, haloxydine, picloram, picolinafen, pyriclor, pyroxsulam, thiazopyr, xyloxadine, and combinations thereof.

In a preferred embodiment, the pyridine class herbicide is triclopyr.

In an embodiment, the cyclohexene oxime class herbicide is selected from the group consisting of clethodim, alloxydim, butroxydim, cloproxydim, cycloxydim, profoxydim, sethoxydim, tepraloxydim, tralkoxydim, and combinations thereof.

In a preferred embodiment, the cyclohexene oxime class herbicide is clethodim.

In an embodiment, the aryloxyphenoxypropionic class herbicide is selected from the group consisting of haloxyfop, chlorazifop, clodinafop, clofop, cyhalofop, diclofop, fenoxaprop, fenoxaprop-P, fenthiaprop, fluazifop, fluazifop-P, haloxyfop-P, isoxapyrifop, kuicaoxi, metamifop, propaquizafop, quizalofop, quizalofop-P, trifop, and combinations thereof.

In a preferred embodiment, the aryloxyphenoxypropionic class herbicide is haloxyfop.

In an embodiment, the triazolone class herbicide is selected from the group consisting of carfentrazone, amicarbazone, bencarbazone, flucarbazone, ipfencarbazone, propoxycarbazone, sulfentrazone, thiencarbazone and combinations thereof.

In a preferred embodiment, the triazolone class herbicide is carfentrazone.

In an embodiment, the uracil class herbicide is selected from the group consisting of bromacil, isocil, lenacil, terbacil, benzfendizone, butafenacil, epyrifenacil, flupropacil, saflufenacil, tiafenacil, and combinations thereof.

In a preferred embodiment, the uracil class herbicide is saflufenacil.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the weight ratio of Glufosinate and the at least one herbicide ranges from 1:100 to 100:1.

In an embodiment, the present invention provides a method of controlling weeds selected from Spermacoce latifolia, Brachiaria decumbens, Eleusine indica, Glycine max at a locus by treating said locus with a combination of L-Glufosinate, and at least one herbicide, wherein the weight ratio of L-Glufosinate and the at least one herbicide ranges from 1:100 to 100:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the weight ratio of Glufosinate and the at least one herbicide ranges from 1:75 to 75:1.

In an embodiment, preferably, the weight ratio between Glufosinate and the at least one herbicide ranges from 1:50 to 50:1.

More preferably, the weight ratio between Glufosinate and the at least one herbicide ranges from 1:25 to 25:1, more preferably 1:10 to 10:1.

In a preferred embodiment, the weight ratio between Glufosinate and the at least one herbicide ranges from 1:5 to 5:1, even more preferably 1:2 to 2:1.

In an embodiment, the present invention provides a method of controlling weeds selected from Spermacoce latifolia, Brachiaria decumbens, Eleusine indica, Glycine max at a locus by treating said locus with a combination of Glufosinate and at least one herbicide, wherein the weight ratio between Glufosinate and the nitrophenyl ether class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the nitrophenyl ether class of herbicides ranges from 1:10 to 10:1, preferably 1:5 to 5:1, more preferably 1:2 to 2:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one imidazolinone herbicide, wherein the weight ratio of Glufosinate and the imidazolinone class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the imidazolinone class of herbicides ranges from 1:10 to 10:1, preferably 1:5 to 5:1, more preferably 1:2 to 2:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the weight ratio of Glufosinate and the imidazolinone class of herbicides ranges from 2:5 to 5:2.

In an embodiment, the present invention provides a method of controlling weeds selected from Spermacoce latifolia, Brachiaria decumbens, Eleusine indica, Glycine max at a locus by treating said locus with a combination of Glufosinate, and at least one dicarboximide herbicide, wherein the weight ratio of Glufosinate and the dicarboximide class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the dicarboximide class of herbicides ranges from 1:10 to 10:1, preferably 1:5 to 5:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one phenoxyacetic herbicide, wherein the weight ratio of Glufosinate and the phenoxyacetic class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the phenoxyacetic class of herbicides ranges from 1:10 to 10:1, preferably 1:5 to 5:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one pyridine herbicide, wherein the weight ratio of Glufosinate and the pyridine class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the pyridine class of herbicides ranges from 1:10 to 10:1, preferably 1:5 to 5:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one cyclohexene oxime herbicide, wherein the weight ratio of Glufosinate and the cyclohexene oxime class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the cyclohexene oxime class of herbicides ranges from 1:10 to 10:1, preferably 1:5 to 5:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one aryloxyphenoxypropionic herbicide, wherein the weight ratio of Glufosinate and the aryloxyphenoxypropionic class of herbicides ranges from 1:100 to 100:1, specifically 1:75 to 75:1, more specifically 1:50 to 50:1, even more specifically 1:25 to 25:1. In a preferred embodiment, the weight ratio between Glufosinate and the aryloxyphenoxypropionic class of herbicides ranges from 1:10 to 10:1, preferably 1:5 to 5:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one triazolone herbicide, wherein the weight ratio of Glufosinate and the triazolone class of herbicides ranges from 1:100 to 100:1, specifically 1:75 to 75:1, more specifically 1:50 to 50:1.

In an embodiment, the present invention provides a method of controlling weeds selected from Spermacoce latifolia, Brachiaria decumbens, Eleusine indica, Glycine max at a locus by treating said locus with a combination of Glufosinate, and at least one uracil herbicide, wherein the weight ratio of Glufosinate and the uracil class of herbicides ranges from 1:100 to 100:1, specifically 1:75 to 75:1, more specifically 1:50 to 50:1.

Further, it was also surprisingly found by the inventors that weeds selected from Spermacoce latifolia, Brachiaria decumbens, Eleusine indica, Glycine max can be completely controlled by the combination of Glufosinate, a herbicide selected from the imidazolinone class of herbicides, and a herbicide selected from the triazolone class of herbicides.

More surprisingly, it was found that this combination of Glufosinate, a herbicide selected from the imidazolinone class of herbicides, and a herbicide selected from the triazolone class of herbicides, acted in a synergistic manner in controlling weeds selected from Spermacoce latifolia, Brachiaria decumbens, Eleusine indica, Glycine max. The degree of synergistic enhancement in efficacy of the above combination towards control of weeds selected from Spermacoce latifolia, Brachiaria decumbens, Eleusine indica, Glycine max was unpredictable and unexpected.

Therefore, in an embodiment, the present invention provides a method of controlling weeds selected from Spermacoce latifolia, Brachiaria decumbens, Eleusine indica, Glycine max at a locus by treating said locus with a combination of Glufosinate, and at least two herbicides, wherein the composition comprises Glufosinate; a herbicide selected from the imidazolinone class of herbicides, and a herbicide selected from the triazolone class of herbicides.

In an embodiment, the present invention provides a method of controlling weeds selected from Spermacoce latifolia, Brachiaria decumbens, Eleusine indica, Glycine max at a locus by treating said locus with a combination of Glufosinate, and at least two herbicides, wherein the herbicide selected from the imidazolinone class of herbicides is imazethapyr, and wherein the herbicide selected from the triazolone class of herbicides is carfentrazone.

In an embodiment, the present invention provides a method of controlling weeds selected from Spermacoce latifolia, Brachiaria decumbens, Eleusine indica, Glycine max at a locus by treating said locus with a combination of Glufosinate, and at least two herbicides, wherein the weight ratio of Glufosinate, and one of the two herbicides ranges between 1:100 to 100:1. Preferably, the weight ratio of Glufosinate, and one of the two herbicides ranges between 1:50 to 50:1, more preferably 1:25 to 25:1. In a yet another preferred embodiment, the weight ratio of Glufosinate, and one of the two herbicides ranges between 1:10 and 10:1, more preferably 1:5 and 5:1 and even more preferably 1:2 and 2:1.

In an embodiment, the present invention provides a method of controlling weeds selected from Spermacoce latifolia, Brachiaria decumbens, Eleusine indica, Glycine max at a locus by treating said locus with a combination of Glufosinate, and at least two herbicides, wherein the weight ratio of the two herbicides ranges between 1:100 to 100:1. Preferably, the weight ratio of the two herbicides ranges between 1:50 to 50:1, more preferably 1:25 to 25:1. In a yet another preferred embodiment, the weight ratio of the two herbicides ranges between 1:10 and 10:1, more preferably 1:5 and 5:1 and even more preferably 1:2 and 2:1.

Preferably, the present invention provides a method of controlling weeds selected from Spermacoce latifolia, Brachiaria decumbens, Eleusine indica, Glycine max at a locus by treating said locus with a combination of Glufosinate, imazethapyr and carfentrazone, wherein the weight ratio of Glufosinate, imazethapyr, and carfentrazone ranges between 1:10:10 to 10:1:1.

The terms “g ai/L” as used herein denotes the concentration of the respective active ingredient in “grams” present “per litre” of the composition.

The terms “g ai/h” as used herein denotes the concentration of the respective active ingredient in “grams” applied “per hectare” of the crop field.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate in an amount in the range of 100 to 400 g ai/L, preferably 180 to 380 g ai/L, more preferably 250 to 350 g ai/L. In a preferred embodiment, the composition comprises 280 g ai/L of Glufosinate.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein Glufosinate is applied at an application rate of 50-350 g ai/h, preferably 100 g ai/h to 250 g ai/h.

In an embodiment, the present invention provides a method of controlling weeds selected from Spermacoce latifolia, Brachiaria decumbens, Eleusine indica, Glycine max at a locus by treating said locus with a combination of L-Glufosinate, and at least one herbicide in a composition, wherein the composition comprises L-Glufosinate in an amount in the range of 100 to 400 g ai/L, preferably 180 to 380 g ai/L, more preferably 250 to 350 g ai/L. In a preferred embodiment, the composition comprises 280 g ai/L of L-Glufosinate.

In an embodiment, the present invention provides a method of controlling weeds selected from Spermacoce latifolia, Brachiaria decumbens, Eleusine indica, Glycine max at a locus by treating said locus with a combination of L-Glufosinate, and at least one herbicide, wherein L-Glufosinate is applied at an application rate of 50-350 g ai/h, preferably 100 g ai/h to 250 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from nitrophenyl ether class of herbicides, and wherein the nitrophenyl ether class of herbicides is present in the composition in an amount in the range of 100 to 400 g ai/L, preferably 140 to 340 g ai/L, more preferably 200 to 250 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the nitrophenyl ether class of herbicides and is applied at an application rate of 5-250 g ai/h, preferably at a rate of 50-150g ai/h and more preferably at a rate of 75-125 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from imidazolinone class of herbicides, and wherein the composition contains an imidazolinone class of herbicide in an amount in the range of 10 to 250 g ai/L, preferably 50-200 g ai/L, more preferably 75-125 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the imidazolinone class of herbicides and is applied at an application rate of 5-200 g ai/h, preferably at a rate of 20 to 150 g ai/h and more preferably at a rate of 50-100 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from organophosphorous class of herbicides, and wherein the composition contains an organophosphorous class of herbicide in an amount in the range of 200 to 1000 g ai/L, preferably 400 to 800 g ai/L, more preferably 500-700 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the organophosphorous class of herbicides and is applied at an application rate of 100-800 g ai/h, preferably at a rate of 200-500 g ai/h, more preferably 300-400 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from dicarboximide class of herbicides, and wherein the composition contains dicarboximide class of herbicides in an amount in the range of 200-800 g ai/L, preferably 300 to 700 g ai/L, more preferably 400-600 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected for the dicarboximide class of herbicides, and is applied at an application rate of Ito 200 g ai/h, preferably 5-100 g ai/h, preferably at a rate of 10-50 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from phenoxyacetic class of herbicides, and wherein the composition contains the phenoxyacetic class of herbicides in an amount in the range of 400 to 1200 g ai/L, preferably 600-1000 g ai/L, more preferably 750-850 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the phenoxyacetic class of herbicides, and is applied at an application rate of 50-400 g ai/h, preferably 100-300 g ai/h, preferably at a rate of 150-250 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from pyridine class of herbicides, wherein the composition contains the pyridine class of herbicides in an amount in the range of 300-1000 g ai/L, preferably 400 to 900 g ai/L, more preferably 500 to 750 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the pyridine class of herbicides, and is applied at an application rate of 50-500 g ai/h, preferably at a rate of 100-400 g ai/h and more preferably 200-350 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from cyclohexene oxime class of herbicides, and wherein the composition has the cyclohexene oxime class of herbicides in an amount in the range of 100-400 g ai/L, preferably 150 to 350 g ai/L, preferably 200-300 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the cyclohexene oxime class of herbicides, and is applied at an application rate of 1-150 g ai/h, preferably at a rate of 10-100 g ai/h, more preferably 25-75 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises Glufosinate and the at least one herbicide selected from aryloxyphenoxypropionic class of herbicides, and wherein the composition has the aryloxyphenoxypropionic class of herbicides in an amount in the range of 1 to 250 g ai/L, preferably 10-200 g ai/L and more preferably 50-150 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the aryloxyphenoxypropionic class of herbicides, and is applied at an application rate of 1-150 g ai/h, preferably at a rate of 10-100 g ai/h, and more preferably at a rate of 25-75 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises the herbicide selected from the triazolone class of herbicides, wherein the composition has the triazolone class of herbicide in an amount in the range of 100-800 g ai/L, preferably 200 to 600 g ai/L, more preferably preferably 300 to 500 g ai/L.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide, wherein the at least one herbicide is selected from the triazolone class of herbicides is applied at an application rate of 0.5-100 g ai/h, preferably at a rate of 1-50 g ai/h, more preferably 2-30 g ai/h.

In an embodiment, the present invention provides a method of controlling weeds selected from Spermacoce latifolia, Brachiaria decumbens, Eleusine indica, Glycine max at a locus by treating said locus with a combination of Glufosinate, and at least one herbicide in a composition, wherein the composition comprises the herbicide selected from the uracil class of herbicides, wherein the composition has the uracil class of herbicide in an amount in the range of 1-1000 g ai/L, preferably 50 to 800 g ai/L.

In an embodiment, the present invention provides a method of controlling weeds selected fromSpermacoce latifolia, Brachiaria decumbens, Eleusine indica, Glycine max at a locus by treating said locus with a combination of Glufosinate, and at least one herbicide, wherein the at least one herbicide is selected from the uracil class of herbicides is applied at an application rate of 10-150 g ai/h, preferably at a rate of 20-70 g ai/h.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant. Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the present invention provides a synergistic composition for controlling Glycine max comprising Glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In a preferred embodiment, the glufosinate is L-glufosinate.

In an embodiment, the present invention provides a synergistic composition for controlling Brachiaria decumbens comprising Glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In a preferred embodiment, the glufosinate is L-glufosinate.

In an embodiment, the present invention provides a synergistic composition for controlling Eleusine indica comprising Glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In a preferred embodiment, the glufosinate is L-glufosinate.

In an embodiment, the present invention provides a synergistic composition for controlling Spermacoce latifolia comprising Glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In a preferred embodiment, the glufosinate is L-glufosinate.

In an embodiment, the present invention provides a synergistic composition for controlling Glycine max comprising L-glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In an embodiment, the present invention provides a synergistic composition for controlling Brachiaria decumbens comprising L-glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In an embodiment, the present invention provides a synergistic composition for controlling Eleusine indica comprising L-glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In an embodiment, the present invention provides a synergistic composition for controlling Spermacoce latifolia comprising L-glufosinate and at least one herbicide selected from:
a. nitrophenyl ether class of herbicides;
b. imidazolinone class of herbicides;
c. organophosphorous class of herbicides;
d. dicarboximide class of herbicides;
e. phenoxyacetic class of herbicides;
f. pyridine class of herbicides;
g. cyclohexene oxime class of herbicides;
h. aryloxyphenoxypropionic class of herbicides;
i. triazolone class of herbicides;
j. uracil class of herbicides, or combinations thereof.

In an embodiment, the weight ratio of Glufosinate and the at least one herbicide ranges from 1:100 to 100:1.

In an embodiment, the weight ratio of L-Glufosinate and the at least one herbicide ranges from 1:100 to 100:1.

In another embodiment, the weight ratio of Glufosinate and the at least one herbicide ranges from 1:75 to 75:1.

In another embodiment, the weight ratio of L-Glufosinate and the at least one herbicide ranges from 1:75 to 75:1.

In an embodiment, the weight ratio between Glufosinate and the at least one herbicide ranges from 1:50 to 50:1.

In an embodiment, the weight ratio between L-Glufosinate and the at least one herbicide ranges from 1:50 to 50:1.

In an embodiment, the weight ratio between Glufosinate and the at least one herbicide ranges from 1:25 to 25:1, more preferably 1:10 to 10:1.

In an embodiment, the weight ratio between Glufosinate and the at least one herbicide ranges from 1:5 to 5:1.

In an embodiment, the weight ratio between L-Glufosinate and the at least one herbicide ranges from 1:5 to 5:1.

In an embodiment, the weight ratio between Glufosinate and the at least one herbicide ranges from 1:2 to 2:1.

In an embodiment, the weight ratio between L-Glufosinate and the at least one herbicide ranges from 1:2 to 2:1.

In an embodiment, Glufosinate is present in the composition in an amount in the range of 100 to 400 g ai/L, preferably 180 to 380 g ai/L.

In an embodiment, L-Glufosinate is present in the composition in an amount in the range of 100 to 400 g ai/L, preferably 180 to 380 g ai/L.

In an embodiment, the at least one herbicide selected from:
a. nitrophenyl ether class of herbicides is present in an amount in the range of 100 to 400 g ai/L, preferably 140 to 340 g ai/L;
b. imidazolinone class of herbicides is present in an amount in the range of 10 to 250 g ai/L, preferably 50-200 g ai/L;
c. organophosphorous class of herbicides is present in an amount in the range of 200 to 1000 g ai/L, preferably 400 to 800 g ai/L;
d. dicarboximide class of herbicides is present in an amount in the range of 200-800 g ai/L, preferably 300 to 700 g ai/L;
e. phenoxyacetic class of herbicides is present in an amount in the range of 400 to 1200 g ai/L, preferably 600-1000 g ai/L;
f. pyridine class of herbicides is present in an amount in the range of 300-1000 g ai/L, preferably 400 to 900 g ai/L;
g. cyclohexene oxime class of herbicides is present in an amount in the range of 100-400 g ai/L, preferably 150 to 350 g ai/L;
h. aryloxyphenoxypropionic class of herbicides is present in an amount in the range of 1 to 250 g ai/L, preferably 10-200 g ai/L; and/or
i. triazolone class of herbicide is present in an amount in the range of 100-800 g ai/L, preferably 200 to 600 g ai/L.

In another embodiment, the present invention provides a synergistic composition for controlling weeds selected from Spermacoce latifolia, Brachiaria decumbens, Eleusine indica, Glycine max comprising Glufosinate; a herbicide selected from the imidazolinone class of herbicides, and a herbicide selected from the triazolone class of herbicides.

In a preferred embodiment, the herbicide selected from the imidazolinone class of herbicides is imazethapyr, and wherein the herbicide selected from the triazolone class of herbicides is carfentrazone.

In an embodiment, the herbicide selected from the imidazolinone class of herbicides, and the herbicide selected from the triazolone class of herbicides are present in the composition in a ratio of 1:100 to 100:1, more preferably 1:10 to 10:1.

In an embodiment, the compositions of the present invention additionally comprise one or more agrochemically suitable excipient such as adjuvants, additives, or carrier along with other ingredients such as surfactants.

The agrochemically suitable excipient may be any one or a combination of adjuvants, co-solvents, surfactants, colorants, dispersants, emulsifiers, thickeners, antifreeze agents, biocides, anti-foam agents, stabilizers, wetting agents or a mixture thereof which may be optionally added to the compositions of the present invention.

The surfactants may be selected from non-ionic, anionic or cationic surfactants.

Examples of nonionic surfactants include polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C8-C22 alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono-and diesters of ethylene glycol and mixtures thereof.

Examples of anionic surfactants include alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono-or di-phosphate esters of polyalkoxylated alkyl alcohols or alkylphenols, mono-or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates and phosphated alkyl phenol ethoxylates.

Cationic surfactants include alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, and phosphate esters of C₈-C₁₈ fatty amine polyalkoxylates.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

In an embodiment, colorants may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

Another embodiment involves addition of a thickener or binder which may be selected from but not limited to molasses, granulated sugar, alginates, karaya gum, jaguar gum, tragacanth gum, polysaccharide gum, mucilage, xanthan gum or combination thereof. In another embodiment, the binder may be selected from silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols.

In another embodiment, antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

According to an embodiment, biocides may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

According to an embodiment, antifoam agent may be selected from Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable & Animal Fats, Vegetable & Animal Fats Sulfate, Vegetable & Animal Oil, Vegetable & Animal Oil Sulfate, Vegetable & Animal Wax, Vegetable & Animal Wax Sulfate, agents based on silicon or magnesium stearate.

Representative organic liquids which can be employed in preparing the emulsifiable concentrates of the present invention are the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of the emulsifiable concentrate. The formulations can also contain other compatible additives, for example, plant growth regulators and other biologically active compounds used in agriculture.

The additives to be used for the formulation include, for example, a solid carrier such as kaolinite, sericite, diatomaceous earth, slaked lime, calcium carbonate, talc, white carbon, kaoline, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

The agrochemical formulation may also comprise one or more antioxidants. Preferably, the agrochemical formulation comprises an antioxidants. Antioxidants are, for example, amino acids (e.g. glycine, histidine, tyrosine, tryptophan) and derivatives thereof, imidazole and imidazole derivatives (e.g. urocanic acid), peptides, such as, for example, D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and further thio compounds (e.g. thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol/kg to pmol/kg), also metal chelating agents (e.g. α-hydroxy fatty acids, EDTA, EGTA, phytic acid, lactoferrin), a-hydroxy acids (e.g. citric acid, lactic acid, malic acid), humic acids, bile acid, bile extracts, gallic esters (e.g. propyl, octyl and dodecyl gallate), flavonoids, catechins, bilirubin, biliverdin and derivatives thereof, unsaturated fatty acids and derivatives thereof (e.g. γ-linolenic acid, linoleic acid, arachidonic acid, oleic acid), folic acid and derivatives thereof, hydroquinone and derivatives thereof (e.g. arbutin), ubiquinone and ubiquinol, and derivatives thereof, vitamin C and derivatives thereof (e.g. ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g. tocopheryl acetate, linoleate, oleate and succinate, tocophereth-5, tocophereth-10, tocophereth-12, tocophereth-18, tocophereth-50, tocophersolan), vitamin A and derivatives (e.g. vitamin A palmitate), the coniferyl benzoate of benzoin resin, rutin, rutinic acid and derivatives thereof, disodium rutinyl disulfate, cinnamic acid and derivatives thereof (e.g. ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g. selenomethionine), stilbenes and stilbene derivatives (e.g. stilbene oxide, trans-stilbene oxide). According to the invention, suitable derivatives (salts, esters, sugars, nucleotides, nucleosides, peptides and lipids) and mixtures of these specified active ingredients or plant extracts (e.g. teatree oil, rosemary extract and rosemarinic acid) which comprise these antioxidants can be used. In general, mixtures of the aforementions antioxidants are possible.

According to an embodiment, examples of suitable solvents are water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

According to an embodiment, suitable surfactants are alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

According to an embodiment, examples of suitable carriers are mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.).

Suitable preservatives are for example 1,2-benzisothiazolin-3-one and/or 2-Methyl-2H-isothiazol-3-one or sodium benzoate or benzoic acid.

In an embodiment, the composition may be in any agriculturally suitable form for storage and application to the ground. The compositions of the present invention may typically be produced by mixing the actives in the composition with an inert carrier, and adding surfactants and other adjuvants and carriers as needed and formulated into solid, or liquid formulations, including but not limited to wettable powders, granules, dusts, soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

The compositions of the present invention maybe applied simultaneously as a tank mix or a formulation or may be applied sequentially. The application may be made to the soil before emergence of the plants, either pre-planting or post-planting. The application may be made to the soil after emergence of the plants. The application may be made as a foliar spray at different timings during crop development, with either one or more applications early or late post-emergence. Herbicidal compositions according to the invention can also be incorporated into the soil before, during or after sowing seeds of a crop. These combinations as described above may be applied to the locus of the weeds, in an herbicidally effective amount.

The compositions of the present invention may be applied in any known ways or conventional methods known to a person skilled in art. Non-limiting examples of such methods are foliar spray, basal barking, stem injection, drill and fill method, axe cut method, cut stump, cut and swab, stem scraper, wick application and so forth. The compositions of the present invention are used in the customary manner, for example by watering, spraying, atomizing, dusting or scattering. Said compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

The present invention is more particularly described in the following examples that are intended as illustration only, since numerous modifications and variations within the scope of the present invention will be apparent to those of skill in the art. Unless otherwise noted, all parts, percentages, and ratios reported in the following examples are on a weight basis, and all reagents used in the examples were obtained or are available from the chemical suppliers.

The following examples illustrates the composition, underlying effect and basic methodology of the present invention.

### EXAMPLES

The following examples demonstrate the present invention.

### Composition

Following active ingredient compounds were used in the present invention to prepare combinations/compositions of L-glufosinate with other herbicides.

| Active ingredient | Dose a.i., g/L |
|---|---|
| L-glufosinate | 280 |
| Oxyfluorfen | 240 |
| Imazethapyr | 106 |
| Carfentrazone | 400 |
| Glyphosate | 648 |
| Flumioxazin | 500 |
| 2,4-D | 670 |
| Triclopyr | 480 |
| Clethodim | 240 |
| Haloxyfop | 124.7 |

Evaluation of Post-Emergence Herbicidal Activity of composition under Field Conditions on Weeds Spermacoce latifolia, Brachiaria decumbens, Eleusine indica, Glycine max

Methodology: Greenhouse trials were carried out to evaluate the efficacy of the combination of L-glufosinate and the other herbicides on Spermacoce latifolia, Brachiaria decumbens, Eleusine indica, Glycine max.

The soil used was sandy clay loam—Sand: 68.0%; Silt: 8.0%; Clay: 24.0%. All treatments were in 3 replications per treatment with a spray volume of 150 L/h.

### Evaluation

The expected efficacy of a combination of L-glufosinate and the other herbicides was calculated using the well-established Colby method. Any difference between the observed and “expected” efficacy could be attributed to synergy between the two compounds.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967 (15), p. 20-22). The Colby method requires only a single dose of each herbicide applied alone and the mixture of both doses. The formula used to calculate the expected efficacy (EE) which was compared with the observed efficacy (OE) to determine the efficacy of the present invention is explained hereinbelow:

The expected efficacy for a combination of two active ingredients is as follows:

$$EE = ( A + B - ( A \times B ) / 100 )$$

The expected efficacy for a combination of three active ingredients is as follows:

$$EE = A + B + C - ( AB + AC + BC ) / 100 + ABC / 10 , 000$$

Where,

A=Observed efficacy of active ingredient A at the same concentration as used in the mixture.

B=Observed efficacy of the active ingredient B at the same concentration as used in the mixture.

C=Observed efficacy of the active ingredient C at the same concentration as used in the mixture.

Spermacoce latifolia

Table 1: Table 1 demonstrates synergy on weeds using the combination of L-glufosinate and oxyfluorfen. The percentage efficacy was calculated after 3, 7, 14, 21, 28, 35 days of applications (DAA). The target weed was Spermacoce latifolia, and the concentration of the herbicide and the results are recorded in the table 1 below:

TABLE 1

| Active | 3 DAA | | 7 DAA | | 14 DAA | | 21 DAA | | 28 DAA | | 35 DAA | |
|---|---|---|---|---|---|---|---|---|---|---|---|---|
| ingredient, | Control | | Control | | Control | | Control | | Control | | Control | |
| dose a.i., g/h | % | Colby* | % | Colby* | % | Colby* | % | Colby* | % | Colby* | % | Colby* |
| L-glufosinate, | 5 | | 35 | | 56.7 | | 56.7 | | 58.3 | | 58.3 | |
| 150 | | | | | | | | | | | | |
| Oxyfluorfen, | 43.3 | | 68.3 | | 77 | | 80.3 | | 77 | | 75.3 | |
| 107.1 | | | | | | | | | | | | |
| L-L- | 51.7 | 46.1 | 85 | 79.4 | 100 | 90 | 100 | 91.5 | 100 | 90.4 | 100 | 89.7 |
| glufosinate, | | | | | | | | | | | | |
| 150 + | | | | | | | | | | | | |
| oxyfluorfen | | | | | | | | | | | | |
| 107.1 | | | | | | | | | | | | |

*Expected control according to Colby’s Formula

Table 2: Table 2 demonstrates synergy on weeds using the combination of L-glufosinate and imazethapyr. The percentage efficacy was calculated after 14, 21, 28, 35 days of applications (DAA). The target weed was Spermacoce latifolia, and the concentration of the herbicide and the results are recorded in the table 2 below:

TABLE 2

| Active ingredient, | 14 DAA | | 21 DAA | | 28 DAA | | 35 DAA | |
|---|---|---|---|---|---|---|---|---|
| dose a.i., g/h | Control % | Colby* | Control % | Colby* | Control % | Colby* | Control % | Colby* |
| L-glufosinate, 150 | 56.7 | | 56.7 | | 58.3 | | 58.3 | |
| Imazethapyr, 75.0 | 30 | | 36.7 | | 30 | | 26.7 | |
| L-L-glufosinate, | 84.3 | 69.7 | 85 | 72.6 | 84.3 | 70.8 | 84.3 | 69.4 |
| 150 + imazethapyr, | | | | | | | | |
| 75 | | | | | | | | |

Table 3: Table 3 demonstrates synergy on weeds using the combination of L-glufosinate and carfentrazone. The percentage efficacy was calculated after 3, 7, 14, 21, 28, 35 days of applications (DAA). The target weed was Spermacoce latifolia, and the concentration of the herbicide and the results are recorded in the table 3 below:

TABLE 3

| Active | 3 DAA | | 7 DAA | | 14 DAA | | 21 DAA | | 28 DAA | | 35 DAA | |
|---|---|---|---|---|---|---|---|---|---|---|---|---|
| ingredient, | Control | | Control | | Control | | Control | | Control | | Control | |
| dose a.i., g/h | % | Colby* | % | Colby* | % | Colby* | % | Colby* | % | Colby* | % | Colby* |
| L-glufosinate, | 5 | | 35 | | 56.7 | | 56.7 | | 58.3 | | 58.3 | |
| 150 | | | | | | | | | | | | |
| Carfentrazone, | 43.3 | | 58.3 | | 64.3 | | 64.3 | | 64.3 | | 63.3 | |
| 7.5 | | | | | | | | | | | | |
| L-L- | 46.7 | 46.1 | 83.3 | 72.9 | 97.7 | 84.5 | 98.7 | 84.5 | 100 | 85.1 | 100 | 84.7 |
| glufosinate, | | | | | | | | | | | | |
| 150 + | | | | | | | | | | | | |
| carfentrazone, | | | | | | | | | | | | |
| 7.5 | | | | | | | | | | | | |

Table 4: Table 4 demonstrates synergy on weeds using the combination of L-glufosinate and carfentrazone. The percentage efficacy was calculated after 14, 21, 28, 35 days of applications (DAA). The target weed was Spermacoce latifolia, and the concentration of the herbicide and the results are recorded in the table 4 below:

TABLE 4

| Active ingredient, | 14 DAA | | 21 DAA | | 28 DAA | | 35 DAA | |
|---|---|---|---|---|---|---|---|---|
| dose a.i., g/h | Control % | Colby* | Control % | Colby* | Control % | Colby* | Control % | Colby* |
| L-glufosinate, 150 | 56.7 | | 56.7 | | 58.3 | | 58.3 | |
| Carfentrazone, 9.0 | 85 | | 87 | | 84.3 | | 82.7 | |
| L-L-glufosinate, | 99.3 | 93.5 | 99.3 | 94.4 | 99.3 | 93.5 | 99.3 | 92.8 |
| 150 + | | | | | | | | |
| carfentrazone, 9 | | | | | | | | |

Table 5: Table 5 demonstrates synergy on weeds using the combination of L-glufosinate, imazethapyr and carfentrazone. The percentage efficacy was calculated after 7, 14, 21, 28, 35 days of applications (DAA). The target weed was Spermacoce latifolia, and the concentration of the herbicide and the results are recorded in the table 5 below:

TABLE 5

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L-glufosinate, | 35 | | 56.7 | | 56.7 | | 58.3 | | 58.3 | |
| 150 | | | | | | | | | | |
| Imazethapyr, | 13.3 | | 30 | | 36.7 | | 30 | | 26.7 | |
| 75.0 | | | | | | | | | | |
| Carfentrazone, | 58.3 | | 64.3 | | 64.3 | | 64.3 | | 63.3 | |
| 7.5 | | | | | | | | | | |
| L-L- | 89 | 76.5 | 99.7 | 89.2 | 99.7 | 90.2 | 100 | 89.6 | 100 | 88.8 |
| glufosinate, | | | | | | | | | | |
| 150 + | | | | | | | | | | |
| imazethapyr, | | | | | | | | | | |
| 75 + | | | | | | | | | | |
| carfentrazone, | | | | | | | | | | |
| 7.5 | | | | | | | | | | |

Table 6: Table 6 demonstrates synergy on weeds using the combination of L-glufosinate and glyphosate. The percentage efficacy was calculated after 7, 14, 21, 28, 35 days of application (DAA). The target weed was Spermacoce latifolia, and the concentration of the herbicide and the results are recorded in the table 6 below:

TABLE 6

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L-glufosinate, | 31.7 | | 81.7 | | 83.3 | | 83.3 | | 83.3 | |
| 150 | | | | | | | | | | |
| Glyphosate, | 10.7 | | 21.7 | | 35 | | 35 | | 35 | |
| 379 | | | | | | | | | | |
| L-glufosinate, | 58.3 | 39 | 90 | 85.7 | 93.3 | 89.1 | 90 | 89.1 | 90 | 89.1 |
| 150 + | | | | | | | | | | |
| glyphosate, | | | | | | | | | | |
| 379 | | | | | | | | | | |

*Expected control according to Colby’s Formula

Table 7: Table 7 demonstrates synergy on weeds using the combination of L-glufosinate and flumioxazin. The percentage efficacy was calculated after 7, 14, 21, 28, 35 days of application (DAA). The target weed was Spermacoce latifolia, and the concentration of the herbicide and the results are recorded in the table 7 below:

TABLE 7

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L-glufosinate, | 31.7 | | 81.7 | | 83.3 | | 83.3 | | 83.3 | |
| 150 | | | | | | | | | | |
| Flumioxazin, | 30 | | 66.7 | | 66.7 | | 75.0 | | 75.0 | |
| 30 | | | | | | | | | | |
| L-glufosinate, | 80 | 52.2 | 95.3 | 93.9 | 98.3 | 94.4 | 100 | 95.8 | 100 | 95.8 |
| 150 + | | | | | | | | | | |
| flumioxazin, | | | | | | | | | | |
| 30 | | | | | | | | | | |

Table 8: Table 8 demonstrates synergy on weeds using the combination of L-glufosinate and 2,4-D. The percentage efficacy was calculated after 7 days of application (DAA). The target weed was Spermacoce latifolia, and the concentration of the herbicide and the results are recorded in the table 8 below:

TABLE 8
DEMONSTRATION OF SYNERGY ON WEEDS USING THE
COMBINATION OF L-GLUFOSINATE AND 2,4-D

7 DAA

| Active ingredient, dose a.i., g/h | Control % | Colby* |
|---|---|---|
| L-glufosinate, 150 | 31.7 | |
| 2,4-D, 204 | 18.3 | |
| L-glufosinate, 150 + 2,4-D, 204 | 50 | 44.2 |

Table 9: Table 9 demonstrates synergy on weeds using the combination of L-glufosinate and triclopyr. The percentage efficacy was calculated after 7, 14, 21 days of application (DAA). The target weed was Spermacoce latifolia, and the concentration of the herbicide and the results are recorded in the table 9 below:

TABLE 9

| | 7 DAA | | 14 DAA | | 21 DAA | |
|---|---|---|---|---|---|---|
| Active ingredient, dose a.i., g/h | Control % | Colby* | Control % | Colby* | Control % | Colby* |
| L-glufosinate, 150 | 31.7 | | 81.7 | | 83.3 | |
| Triclopyr, 288 | 45 | | 75 | | 91.7 | |
| L-glufosinate, 150 + 2,4-D, 204 | 50 | 44.2 | 78.7 | 87.5 | 83.7 | 89.7 |
| L-glufosinate, 150 + triclopyr, 288 | 75 | 62.4 | 100 | 95.4 | 100 | 98.6 |

Table 10: Table 6 demonstrates synergy on weeds using the combination of L-glufosinate and clethodim. The percentage efficacy was calculated after 7 days of application (DAA). The target weed was Spermacoce latifolia, and the concentration of the herbicide and the results are recorded in the table 10 below:

TABLE 10
DEMONSTRATION OF SYNERGY ON WEEDS USING THE
COMBINATION OF L-GLUFOSINATE AND CLETHODIM

7 DAA

| Active ingredient, dose a.i., g/h | Control % | Colby* |
|---|---|---|
| L-glufosinate, 150 | 31.7 | |
| Clethodim, 45 | 3 | |
| L-glufosinate, 150 + clethodim, 45 | 61.7 | 33.7 |

Table 11: Table 11 demonstrates synergy on weeds using the combination of L-glufosinate and haloxyfop. The percentage efficacy was calculated after 7, 14, 21, 28, 35 days of application (DAA). The target weed was Spermacoce latifolia, and the concentration of the herbicide and the results are recorded in the table 11 below:

TABLE 11

| Active | 7 DAA | | 14 DAA | | 21 DAA | | 28 DAA | | 35 DAA | |
|---|---|---|---|---|---|---|---|---|---|---|
| ingredient, | Control | | Control | | Control | | Control | | Control | |
| dose a.i., g/h | % | Colby* | % | Colby* | % | Colby* | % | Colby* | % | Colby* |
| L- | 31.7 | | 81.7 | | 83.3 | | 83.3 | | 83.3 | |
| glufosinate, | | | | | | | | | | |
| 150 | | | | | | | | | | |
| Haloxyfop, | 8 | | 8.7 | | 10 | | 31 | | 9.3 | |
| 50 | | | | | | | | | | |
| L- | 68.3 | 37.2 | 93.3 | 83.3 | 99.3 | 85 | 100 | 88.5 | 100 | 84.9 |
| glufosinate, | | | | | | | | | | |
| 150 + | | | | | | | | | | |
| haloxyfop, | | | | | | | | | | |
| 50 | | | | | | | | | | |

The results in tables 1-11 clearly demonstrate synergy between L-glufosinate and the other herbicides. The large difference between the observed and the expected efficacy clearly demonstrates the synergistic effect of the combination.

Brachiaria decumbens

Table 1: Table 1 demonstrates synergy on weeds using the combination of L-Glufosinate and other herbicides. The percentage efficacy was calculated after 7, 14, 21, 28, 35 days of applications (DAA). The target weed was Brachiaria decumbens, and the concentration of the herbicide and the results are recorded in the table 1 below:

| Active ingredient, | 7 DAA | | 14 DAA | | 21 DAA | | 28 DAA | | 35 DAA | |
|---|---|---|---|---|---|---|---|---|---|---|
| dose a.i., g/h | Control % | Colby* | Control % | Colby* | Control % | Colby* | Control % | Colby* | Control % | Colby* |
| L-Glufosinate, 150 | 46 | | 54.3 | | 53.3 | | 48.3 | | 42 | |
| Oxyfluorfen, 107.1 | 41.7 | | 42 | | 44.3 | | 38.3 | | 33.3 | |
| Imazethapyr, 75.0 | 10 | | 10 | | 15 | | 10 | | 5 | |
| Carfentrazone, 7.5 | 14 | | 16.7 | | 15 | | 5 | | 0 | |
| Carfentrazone, 9.0 | 15 | | 16 | | 19.3 | | 18.3 | | 11.3 | |
| L-Glufosinate, 150 + | 80 | 68.5 | 98 | 73.5 | 98.3 | 74 | 97.7 | 68.1 | 97.7 | 61.3 |
| oxyfluorfen 107.1 | | | | | | | | | | |
| L-Glufosinate, 150 + | 56.7 | 51.4 | 79.3 | 58.9 | 82.7 | 60.3 | 81.0 | 53.5 | 81.0 | 44.9 |
| imazethapyr, 75 | | | | | | | | | | |
| L-Glufosinate, 150 + | 67 | 53.6 | 81.7 | 61.9 | 84.7 | 60.3 | 81.7 | 50.9 | 81.7 | 42 |
| carfentrazone, 7.5 | | | | | | | | | | |
| L-Glufosinate, 150 + | 65 | 54.1 | 77.7 | 61.6 | 83.7 | 62.3 | 80.3 | 57.8 | 79.3 | 48.6 |
| carfentrazone, 9 | | | | | | | | | | |
| L-Glufosinate, 150 + | 66 | 58.2 | 84.3 | 65.7 | 90 | 66.3 | 87.7 | 55.8 | 85.7 | 44.9 |
| imazethapyr, 75 + | | | | | | | | | | |
| carfentrazone, 7.5 | | | | | | | | | | |

*Expected control according to Colby's Formula

Table 2: Table 2 demonstrates synergy on weeds using the combination of L-Glufosinate and other glyphosate. The percentage efficacy was calculated after 7, 21, 28, 35 days of applications (DAA). The target weed was Brachiaria decumbens, and the concentration of the herbicide and the results are recorded in the table 2 below:

| Active ingredient, | 7 DAA | | 21 DAA | | 28 DAA | | 35 DAA | |
|---|---|---|---|---|---|---|---|---|
| dose a.i., g/h | Control % | Colby* | Control % | Colby* | Control % | Colby* | Control % | Colby* |
| L-Glufosinate, 150 | 50 | | 82 | | 79.3 | | 79.3 | |
| Glyphosate, 379 | 15 | | 73.3 | | 70.0 | | 66.7 | |
| L-Glufosinate, 150 + | 69.3 | 57.5 | 97.3 | 95.2 | 97.3 | 93.8 | 96.7 | 93.1 |
| glyphosate, 379 | | | | | | | | |

*Expected control according to Colby's Formula

Table 3: Table 3 demonstrates synergy on weeds using the combination of L-Glufosinate and other herbicides. The percentage efficacy was calculated after 7, 14, 21, 28, 35 days of application (DAA). The target weed was Brachiaria decumbens, and the concentration of the herbicide and the results are recorded in the table 3 below:

| Active ingredient, | 7 DAA | | 14 DAA | | 21 DAA | | 28 DAA | | 35 DAA | |
|---|---|---|---|---|---|---|---|---|---|---|
| dose a.i., g/h | Control % | Colby* | Control % | Colby* | Control % | Colby* | Control % | Colby* | Control % | Colby* |
| L-Glufosinate, 150 | 50 | | 79.3 | | 82 | | 79.3 | | 79.3 | |
| Flumioxazin, 30 | 35 | | 42.3 | | 43.3 | | 40 | | 35 | |
| 2,4-D, 204 | 4.3 | | 5 | | 3.3 | | 3.3 | | 3.3 | |
| Triclopyr, 288 | 7 | | 8.3 | | 8.3 | | 8.3 | | 8.3 | |
| Clethodim, 45 | 15 | | 55 | | 65 | | 75 | | 71 | |
| L-Glufosinate, 150 + | 81.7 | 67.5 | 90.7 | 88.1 | 95.7 | 89.8 | 95 | 87.6 | 94.3 | 86.5 |
| flumioxazin, 30 | | | | | | | | | | |
| L-Glufosinate, 150 + | 68.7 | 52.2 | 87.7 | 80.3 | 91 | 82.6 | 91 | 80 | 91 | 80 |
| 2,4-D, 204 | | | | | | | | | | |
| L-Glufosinate, 150 + | 65.7 | 53.5 | 87 | 81 | 87 | 83.5 | 84.3 | 81 | 82.3 | 81 |
| triclopyr, 288 | | | | | | | | | | |
| L-Glufosinate, 150 + | 68.3 | 57.5 | 99 | 90.7 | 100 | 93.7 | 100 | 94.8 | 100 | 94 |
| clethodim, 45 | | | | | | | | | | |

Table 4: Table 4 demonstrates synergy on weeds using the combination of L-Glufosinate and haloxyfop. The percentage efficacy was calculated after 7, 14, 21 days of application (DAA). The target weed was Brachiaria decumbens, and the concentration of the herbicide and the results are recorded in the table 4 below:

| Active ingredient, | 7 DAA | | 14 DAA | | 21 DAA | | 28 DAA | | 35 DAA | |
|---|---|---|---|---|---|---|---|---|---|---|
| dose a.i., g/h | Control % | Colby* | Control % | Colby* | Control % | Colby* | Control % | Colby* | Control % | Colby* |
| L-Glufosinate, 150 | 50 | | 79.3 | | 82 | | 79.3 | | 79.3 | |
| Haloxyfop, 50 | 26.7 | | 75.3 | | 92 | | 99.3 | | 100 | |
| L-Glufosinate, 150 + | 67.7 | 63.4 | 98.7 | 94.9 | 98.7 | 98.6 | 98.7 | 99.9 | 98.7 | 100 |
| haloxyfop, 50 | | | | | | | | | | |

The results in tables 1-4 clearly demonstrate synergy between L-Glufosinate and the other herbicides. The large difference between the observed and the expected efficacy clearly demonstrates the synergistic effect of the combination.

Eleusine indica

Table 1: Table 1 demonstrates synergy on weeds using the combination of L-Glufosinate and other herbicides. The percentage efficacy was calculated after 7, 14, 21, 28, 35 days of applications (DAA). The target weed was Eleusine indica, and the concentration of the herbicide and the results are recorded in the table 1 below:

| Active ingredient, | 7 DAA | | 14 DAA | | 21 DAA | | 28 DAA | | 35 DAA | |
|---|---|---|---|---|---|---|---|---|---|---|
| dose a.i., g/h | Control % | Colby* | Control % | Colby* | Control % | Colby* | Control % | Colby* | Control % | Colby* |
| L-glufosinate, 150 | 43.3 | | 41.3 | — | 37.3 | — | 28.3 | — | 25.3 | — |
| Oxyfluorfen, 107.1 | 44 | | 40 | — | 37 | — | 28.3 | — | 23.3 | — |
| Imazethapyr, 75.0 | 8.3 | | 12 | — | 12.7 | — | 12.7 | — | 10 | — |
| Carfentrazone, 7.5 | 14 | | 12.3 | — | 11 | — | 7.7 | — | 0 | — |
| Carfentrazone, 9.0 | 16.7 | | 16.7 | — | 14 | — | 12.3 | — | 6.7 | — |
| L-glufosinate, 150 + | 83.3 | 68.2 | 88.7 | 64.8 | 90.7 | 60.5 | 89.7 | 48.6 | 90.3 | 42.7 |
| oxyfluorfen 107.1 | | | | | | | | | | |
| L-glufosinate, 150 + | 58.3 | 48 | 75.3 | 48.3 | 80 | 45.3 | 78.7 | 37.4 | 76.7 | 32.8 |
| imazethapyr, 75 | | | | | | | | | | |
| L-glufosinate, 150 + | 67.7 | 51.2 | 72.3 | 48.5 | 75.7 | 44.2 | 75 | 33.8 | 75 | 25.3 |
| carfentrazone, 7.5 | | | | | | | | | | |
| L-glufosinate, 150 + | 58.3 | 52.8 | 72.7 | 51.1 | 74.3 | 46.1 | 72.7 | 37.1 | 72.7 | 30.3 |
| carfentrazone, 9 | | | | | | | | | | |
| L-glufosinate, 150 + | 69.3 | 55.3 | 84.3 | 54.7 | 86.7 | 51.3 | 84.7 | 42.2 | 82.7 | 32.8 |
| imazethapyr, 75 + | | | | | | | | | | |
| carfentrazone, 7.5 | | | | | | | | | | |

* Expected control according to Colby's Formula

Table 2: Table 2 demonstrates synergy on weeds using the combination of L-Glufosinate and glyphosate. The percentage efficacy was calculated after 7 and 35 days of application (DAA). The target weed was Eleusine indica, and the concentration of the herbicide and the results are recorded in the table 2 below:

| | 7 DAA | | 35 DAA | |
|---|---|---|---|---|
| Active ingredient, | | *Colby | | *Colby |
| g ai/h | % control | value | % control | value |
| L-glufosinate, 150 | 50.7 | — | 54.3 | — |
| Glyphosate, 379 | 28.3 | — | 81.7 | — |
| L-glufosinate, 150 + | 66.7 | 64.7 | 91.7 | 91.6 |
| Glyphosate, 379 | | | | |

*Expected control according to Colby's Formula

Table 3: Table 3 demonstrates synergy on weeds using the combination of L-Glufosinate and flumioxazin. The percentage efficacy was calculated after 3, 7, 14, 21, 28, 35 days of application (DAA). The target weed was Eleusine indica, and the concentration of the herbicide and the results are recorded in the table 3 below:

| | 3 DAA | | 7 DAA | | 14 DAA | | 21 DAA | | 28 DAA | | 35 DAA | |
|---|---|---|---|---|---|---|---|---|---|---|---|---|
| Active | % | Colby | % | Colby | % | Colby | % | Colby | % | Colby | % | Colby |
| ingredient, g ai/h | control | value | control | value | control | value | control | value | control | value | control | value |
| L-glufosinate, 150 | 12.3 | — | 50.7 | — | 65.0 | — | 64.3 | — | 59.3 | — | 54.3 | — |
| Flumioxazin, 30 | 5.0 | — | 28.3 | — | 21.7 | — | 10 | — | 5 | — | 0 | — |
| L-glufosinate, 150 + | 27.7 | 16.7 | 77 | 64.7 | 80 | 72.6 | 76 | 67.9 | 75 | 61.3 | 75 | 54.3 |
| Flumioxazin, 30 | | | | | | | | | | | | |

Table 4: Table 4 demonstrates synergy on weeds using the combination of L-Glufosinate and 2,4-D. The percentage efficacy was calculated after 3, 7, 14, 21, 28, 35 days of application (DAA). The target weed was Eleusine indica, and the concentration of the herbicide and the results are recorded in the table 4 below:

| | 3 DAA | | 7 DAA | | 14 DAA | | 21 DAA | | 28 DAA | | 35 DAA | |
|---|---|---|---|---|---|---|---|---|---|---|---|---|
| Active | % | Colby | % | Colby | % | Colby | % | Colby | % | Colby | % | Colby |
| ingredient, g ai/h | control | value | control | value | control | value | control | value | control | value | control | value |
| L-glufosinate, 150 | 12.3 | — | 50.7 | — | 65.0 | — | 64.3 | — | 59.3 | — | 54.3 | — |
| 2,4-D, 204 | 5 | — | 4 | — | 6.7 | — | 5 | — | 5 | — | 0 | — |
| L-glufosinate, 150 + | 19.3 | 16.7 | 70 | 52.7 | 81.7 | 67.3 | 78.3 | 66.1 | 75 | 61.3 | 72 | 54.3 |
| 2,4-D, 204 | | | | | | | | | | | | |

Table 5: Table 5 demonstrates synergy on weeds using the combination of L-Glufosinate and triclopyr. The percentage efficacy was calculated after 7, 14, 21, 28 and 35 days of application (DAA). The target weed was Eleusine indica, and the concentration of the herbicide and the results are recorded in the table 5 below:

| | 7 DAA | | 14 DAA | | 21 DAA | | 28 DAA | | 35 DAA | |
|---|---|---|---|---|---|---|---|---|---|---|
| Active | % | Colby | % | Colby | % | Colby | % | Colby | % | Colby |
| ingredient, g ai/h | control | value | control | value | control | value | control | value | control | value |
| L-glufosinate, 150 | 50.7 | — | 65.0 | — | 64.3 | — | 59.3 | — | 54.3 | — |
| Triclopyr, 288 | 8 | — | 13.3 | — | 6.7 | — | 6.7 | — | 6.7 | — |
| L-glufosinate, 150 + | 55 | 54.6 | 70.3 | 69.7 | 67.3 | 66.7 | 63.3 | 62 | 62 | 57.4 |
| triclopyr, 288 | | | | | | | | | | |

Table 6: Table 6 demonstrates synergy on weeds using the combination of L-Glufosinate and clethodim. The percentage efficacy was calculated after 3, 7, 28, 35 days of application (DAA). The target weed was Eleusine indica, and the concentration of the herbicide and the results are recorded in the table 6 below:

| | 3 DAA | | 7 DAA | | 28 DAA | | 35 DAA | |
|---|---|---|---|---|---|---|---|---|
| Active | % | Colby | % | Colby | % | Colby | % | Colby |
| ingredient, g ai/h | control | value | control | value | control | value | control | value |
| L-glufosinate, 150 | 12.3 | — | 50.7 | — | 59.3 | — | 54.3 | — |
| Clethodim, 45 | 6.7 | — | 15 | — | 81.7 | — | 84.3 | — |
| L-glufosinate, 150 + | 20 | 18.2 | 65 | 58.1 | 93.7 | 92.6 | 95.3 | 92.8 |
| clethodim, 45 | | | | | | | | |

Table 7: Table 7 demonstrates synergy on weeds using the combination of L-Glufosinate and haloxyfop. The percentage efficacy was calculated after 7 days of application (DAA). The target weed was Eleusine indica, and the concentration of the herbicide and the results are recorded in the table 7 below:

| | 7 DAA | |
|---|---|---|
| Active ingredient, g ai/h | % control | Colby value |
| L-glufosinate, 150 | 50.7 | — |
| Haloxyfop, 50 | 25 | — |
| L-glufosinate, 150 + haloxyfop, 50 | 65 | 63 |

The results in tables 1 and 2-7 clearly demonstrate synergy between L-Glufosinate and the other herbicides. The large difference between the observed and the expected efficacy clearly demonstrates the synergistic effect of the combination.

### Glycine max

Table 1: Table 1 demonstrates synergy on weeds using the combination of L-Glufosinate and other herbicides. The percentage efficacy was calculated after 14, 21, 28, 35 days of applications (DAA). The target weed was Glycine max, and the concentration of the herbicide and the results are recorded in the table 1 below:

| Active ingredient, | 14 DAA | | 21 DAA | | 28 DAA | | 35 DAA | |
|---|---|---|---|---|---|---|---|---|
| dose a.i., g/h | Control % | Colby* | Control % | Colby* | Control % | Colby* | Control % | Colby* |
| L-Glufosinate, 150 | 60 | — | 63.3 | — | 63.3 | — | 52.7 | — |
| Oxyfluorfen, 107.1 | 46.7 | — | 45.0 | — | 43.3 | — | 35.0 | — |
| Imazethapyr, 75.0 | 10 | — | 20.0 | — | 20.0 | — | 15.0 | — |
| Carfentrazone, 7.5 | 50.3 | — | 44.3 | — | 44.3 | — | 39.3 | — |
| Carfentrazone, 9.0 | 51.7 | — | 51.0 | — | 51.0 | — | 46.7 | — |
| L-Glufosinate, 150 + | 87.7 | 78.7 | 86.3 | 79.8 | 83.7 | 79.2 | 81.0 | 69.3 |
| oxyfluorfen 107.1 | | | | | | | | |
| L-Glufosinate, 150 + | 85.0 | 64.0 | 83.7 | 70.6 | 82 | 70.6 | 78.7 | 59.8 |
| imazethapyr, 75 | | | | | | | | |
| L-Glufosinate, 150 + | 89.3 | 80.1 | 90.0 | 79.6 | 90.7 | 79.6 | 89.3 | 71.3 |
| carfentrazone, 7.5 | | | | | | | | |
| L-Glufosinate, 150 + | 89 | 80.7 | 91.7 | 82.0 | 93.3 | 82.0 | 91.3 | 74.8 |
| carfentrazone, 9 | | | | | | | | |
| L-Glufosinate, 150 + | 89.3 | 82.1 | 95.3 | 83.6 | 96.7 | 83.6 | 96.0 | 75.6 |
| imazethapyr, 75 + | | | | | | | | |
| carfentrazone, 7.5 | | | | | | | | |

*Expected control according to Colby's Formula

Table 2: Table 2 demonstrates synergy on weeds using the combination of L-Glufosinate and glyphosate. The percentage efficacy was calculated after 3, 7, 14, 21, 28, 35 days of application (DAA). The target weed was Glycine max, and the concentration of the herbicide and the results are recorded in the table 2 below:

| | 3 DAA | | 7 DAA | | 14 DAA | | 21 DAA | | 28 DAA | | 35 DAA | |
|---|---|---|---|---|---|---|---|---|---|---|---|---|
| Active | % | Colby | % | Colby | % | Colby | % | Colby | % | Colby | % | Colby |
| ingredient, g ai/h | control | value | control | value | control | value | control | value | control | value | control | value |
| L-Glufosinate, 150 | 15 | — | 53.3 | — | 71 | — | 66.7 | — | 56.7 | — | 41.7 | — |
| Glyphosate, 379 | 0 | — | 0 | — | 0 | — | 0 | — | 0 | — | 0 | — |
| L-Glufosinate, 150 + | 29.3 | 15 | 76 | 53.3 | 90 | 71 | 93 | 66.7 | 93 | 56.7 | 90.7 | 41.7 |
| Glyphosate, 379 | | | | | | | | | | | | |

*Expected control according to Colby's Formula

Table 3: Table 3 demonstrates synergy on weeds using the combination of L-Glufosinate and flumioxazin. The percentage efficacy was calculated after 3, 7, 21, 28, 35 days of application (DAA). The target weed was Glycine max, and the concentration of the herbicide and the results are recorded in the table 3 below.

| | 3 DAA | | 7 DAA | | 21 DAA | | 28 DAA | | 35 DAA | |
|---|---|---|---|---|---|---|---|---|---|---|
| Active | % | Colby | % | Colby | % | Colby | % | Colby | % | Colby |
| ingredient, g ai/h | control | value | control | value | control | value | control | value | control | value |
| L-Glufosinate, 150 | 15 | — | 53.3 | — | 66.7 | — | 56.7 | — | 41.7 | — |
| Flumioxazin, 30 | 7.7 | — | 31.7 | — | 40 | — | 40 | — | 30 | — |
| L-Glufosinate, 150 + | 35.3 | 21.5 | 75.7 | 68.1 | 83.3 | 80 | 81.7 | 74 | 76.7 | 59.2 |
| Flumioxazin, 30 | | | | | | | | | | |

Table 4: Table 4 demonstrates synergy on weeds using the combination of L-Glufosinate and 2,4-D. The percentage efficacy was calculated after 7, 14, 21, 28, 35 days of application (DAA). The target weed was Glycine max, and the concentration of the herbicide and the results are recorded in the table 4 below:

| | 7 DAA | | 14 DAA | | 21 DAA | | 28 DAA | | 35 DAA | |
|---|---|---|---|---|---|---|---|---|---|---|
| Active | % | Colby | % | Colby | % | Colby | % | Colby | % | Colby |
| ingredient, g ai/h | control | value | control | value | control | value | control | value | control | value |
| L-Glufosinate, 150 | 53.3 | — | 71 | — | 66.7 | — | 56.7 | — | 41.7 | — |
| 2,4-D, 204 | 41.7 | — | 42.7 | — | 50.7 | — | 53.3 | — | 48.3 | — |
| L-Glufosinate, 150 + | 77 | 72.8 | 89.3 | 83.4 | 93.3 | 83.6 | 90 | 79.8 | 84.3 | 69.9 |
| 2,4-d, 204 | | | | | | | | | | |

Table 5: Table 5 demonstrates synergy on weeds using the combination of L-Glufosinate and triclopyr. The percentage efficacy was calculated after 7 and 14 days of application (DAA). The target weed was Glycine max, and the concentration of the herbicide and the results are recorded in the table 5 below:

| | 7 DAA | | 14 DAA | |
|---|---|---|---|---|
| Active ingredient, g ai/h | % control | Colby value | % control | Colby value |
| L-Glufosinate, 150 | 53.3 | — | 71 | — |
| Triclopyr, 288 | 50 | — | 79.3 | — |
| L-Glufosinate, 150 + | 82.7 | 76.7 | 98.3 | 94 |
| triclopyr, 288 | | | | |

Table 6: Table 6 demonstrates synergy on weeds using the combination of L-Glufosinate and clethodim. The percentage efficacy was calculated after 3, 7, 14, 21, 28, 35 days of application (DAA). The target weed was Glycine max, and the concentration of the herbicide and the results are recorded in the table 6 below.

| | 3 DAA | | 7 DAA | | 14 DAA | | 21 DAA | | 28 DAA | | 35 DAA | |
|---|---|---|---|---|---|---|---|---|---|---|---|---|
| Active | % | Colby | % | Colby | % | Colby | % | Colby | % | Colby | % | Colby |
| ingredient, g ai/h | control | value | control | value | control | value | control | value | control | value | control | value |
| L-Glufosinate, 150 | 15 | — | 53.3 | — | 71 | — | 66.7 | — | 56.7 | — | 41.7 | — |
| Clethodim, 45 | 0 | — | 0 | — | 0 | — | 0 | — | 0 | — | 0 | — |
| L-Glufosinate, 150 + | 30 | 15 | 75.3 | 53.3 | 87 | 71 | 88 | 66.7 | 85.7 | 56.7 | 82.7 | 41.7 |
| clethodim, 45 | | | | | | | | | | | | |

Table 7: Table 7 demonstrates synergy on weeds using the combination of L-Glufosinate and haloxyfop. The percentage efficacy was calculated after 3, 7, 14, 21, 28, 35 days of application (DAA). The target weed was Glycine max, and the concentration of the herbicide and the results are recorded in the table 7 below:

| | 3 DAA | | 7 DAA | | 14 DAA | | 21 DAA | | 28 DAA | | 35 DAA | |
|---|---|---|---|---|---|---|---|---|---|---|---|---|
| Active | % | Colby | % | Colby | % | Colby | % | Colby | % | Colby | % | Colby |
| ingredient, g ai/h | control | value | control | value | control | value | control | value | control | value | control | value |
| L-Glufosinate, 150 | 15 | — | 53.3 | — | 71 | — | 66.7 | — | 56.7 | — | 41.7 | — |
| Haloxyfop, 50 | 5 | — | 13.3 | — | 15 | — | 12.3 | — | 12.3 | — | 12.3 | — |
| L-Glufosinate, 150 + | 31 | 19.3 | 87.3 | 59.5 | 91 | 75.4 | 92.3 | 70.8 | 90 | 62 | 88.3 | 48.9 |
| haloxyfop, 50 | | | | | | | | | | | | |

The results in tables 1 and 2-7 clearly demonstrate synergy between L-Glufosinate and the other herbicides. The large difference between the observed and the expected efficacy clearly demonstrates the synergistic effect of the combination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should, therefore, not be limited by the above-described embodiment, method, and examples, but by all embodiments and methods within the scope and spirit of the invention.

We claim:

1. A method comprising controlling growth of undesirable vegetation at a locus by treating the locus with a synergistic combination comprising glufosinate and at least one herbicide selected from:
(a) nitrophenyl ether class herbicides;
(b) imidazolinone class herbicides;
(c) organophosphorous class herbicides;
(d) dicarboximide class herbicides;
(e) phenoxyacetic class herbicides;
(f) pyridine class herbicides;
(g) cyclohexene oxime class herbicides;
(h) aryloxyphenoxypropionic class herbicides;
(i) triazolone class herbicides, (j) uracil class herbicides, and combinations thereof, wherein the undesirable vegetation is selected from group consisting of Spermacoce latifolia, Brachiaria decumbens, Eleusine indica, Glycine max.

2. The method as claimed in claim 1, wherein the glufosinate is L-glufosinate.

3. The method as claimed in claim 1, wherein:
(a) the nitrophenyl ether class herbicide is selected from the group consisting of oxyfluorfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, and combinations thereof;
(b) the imidazolinone class herbicide is selected from the group consisting of imazethapyr, imazamethabenz, imazamox, imazapic, imazapyr, imazaquin, and combinations thereof;
(c) the organophosphorous class herbicide is selected from the group consisting of glyphosate, amiprofos-methyl, amiprophos, anilofos, bensulide, bilanafos, butamifos, clacyfos, 2,4-DEP, DMPA ((O-(2,4-dichlorophenyl) O-methyl isopropylphosphoramidothioate)), EBEP (ethyl bis(2-ethylhexyl)phosphinate), fosamine, glufosinate-P, huangcaoling, piperophos, shuangjiaancaolin and combinations thereof;
(d) the dicarboximide class herbicide is selected from the group consisting of cinidon-ethyl, flumezin, flumiclorac, flumioxazin, flumipropyn, and combinations thereof;
(e) the phenoxyacetic class herbicide is selected from the group consisting of clacyfos, 4-CPA (p-Chlorophenoxyacetic acid), 2,4-D, 3,4-DA, MCPA (2-methyl-4-chlorophenoxyacetic acid), MCPA-thioethyl, 2,4,5-T and combinations thereof;
(f) the pyridine class herbicide is selected from the group consisting of aminopyralid, cliodinate, clopyralid, diflufenican, dithiopyr, florpyrauxifen, flufenican, fluroxypyr, halauxifen, haloxydine, picloram, picolinafen, pyriclor, pyroxsulam, thiazopyr, triclopyr, xyloxadine, and combinations thereof;
(g) the cyclohexene oxime class herbicide is selected from the group consisting of alloxydim, butroxydim, clethodim, cloproxydim, cycloxydim, profoxydim, sethoxydim, tepraloxydim, tralkoxydim, and combinations thereof;
(h) the aryloxyphenoxypropionic class herbicide is selected from the group consisting of chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop, and combinations thereof;
(i) the triazolone class herbicide is selected from the group consisting of amicarbazone, bencarbazone, carfentrazone, flucarbazone, ipfencarbazone, propoxycarbazone, sulfentrazone, thiencarbazone and combinations thereof; and/or
(j) the uracil class herbicide is selected from the group consisting of bromacil, isocil, lenacil, terbacil, benzfendizone, butafenacil, epyrifenacil, flupropacil, saflufenacil, tiafenacil, and combinations thereof.

4. The method as claimed in claim 3, wherein:
(a) the nitrophenyl ether class herbicide is oxyfluorfen;
(b) the imidazolinone class herbicide is imazethapyr;
(c) the organophosphorous class herbicide is glyphosate;
(d) the dicarboximide class herbicide is flumioxazin;
(e) the phenoxyacetic class herbicide is 2,4-D;
(f) the pyridine class herbicide is triclopyr;
(g) the cyclohexene oxime class herbicide is clethodim;
(h) the aryloxyphenoxypropionic class herbicide is haloxyfop;
(i) the triazolone class herbicide is carfentrazone; and/or
(j) the uracil class herbicide is saflufenacil.

5. The method as claimed in claim 1, wherein the weight ratio of glufosinate and the at least one herbicide is 1:100 to 100:1.

6. The method as claimed in claim 5, wherein the weight ratio of glufosinate and the at least one herbicide is 1:75 to 75:1.

7. The method as claimed in claim 1, wherein the glufosinate is present in an amount in the range of 100 to 400 g ai/L, preferably 180 to 380 g ai/L.

8. The method as claimed in claim 1, wherein at least one herbicide selected from
(a) the nitrophenyl ether class herbicide present in an amount in the range of 100 to 400 g ai/L, preferably 140 to 340 g ai/L;
(b) the imidazolinone class herbicide present in an amount in the range of 10 to 250 g ai/L, preferably 50-200 g ai/L;
(c) the organophosphorous class herbicide present in an amount in the range of 200 to 1000 g ai/L, preferably 400 to 800 g ai/L;
(d) the dicarboximide class herbicide present in an amount in the range of 200-800 g ai/L, preferably 300 to 700 g ai/L;
(e) the phenoxyacetic class herbicide present in an amount in the range of 400 to 1200 g ai/L, preferably 600-1000 g ai/L;
(f) the pyridine class herbicide present in an amount in the range of 300-1000 g ai/L, preferably 400 to 900 g ai/L;
(g) the cyclohexene oxime class herbicide present in an amount in the range of 100-400 g ai/L, preferably 150 to 350 g ai/L;
(h) the aryloxyphenoxypropionic class herbicides present in an amount in the range of 1 to 250 g ai/L, preferably 10-200 g ai/L;
(i) the triazolone class herbicide present in an amount in the range of 100-800 g ai/L, preferably 200 to 600 g ai/L; and/or
(j) the uracil class herbicide present in an amount in the range of 1-1000 g ai/L, preferably 50 to 800 g ai/L.

9. The method as claimed in claim 1, wherein the glufosinate is applied at an application rate of 50-350 g ai/h, preferably 100 g ai/h to 250 g ai/h.

10. The method as claimed in claim 1, wherein the at least one herbicide is selected from
(a) the nitrophenyl ether class herbicide applied at an application rate of 5-250 g ai/h, preferably at a rate of 50-150 g ai/h;
(b) the imidazolinone class herbicides is applied at an application rate of 5-200 g ai/h, preferably at a rate of 20 to 150 g ai/h;
(c) the organophosphorous class herbicide applied at an application rate of 100-800 g ai/h, preferably at a rate of 200-500 g ai/h;
(d) the dicarboximide class herbicide applied at an application rate of 1 to 200 g ai/h, preferably 5-100 g ai/h;
(e) the phenoxyacetic class herbicide applied at an application rate of 50-400 g ai/h, preferably 100-300 g ai/h;
(f) the pyridine class herbicide applied at an application rate of 50-500 g ai/h, preferably at a rate of 100-400 g ai/h;
(g) the cyclohexene oxime class herbicide applied at an application rate of 1-150 g ai/h, preferably at a rate of 10-100 g ai/h;
(h) the aryloxyphenoxypropionic class herbicides is applied at an application rate of 1-150 g ai/h, preferably at a rate of 10-100 g ai/h;
(i) the triazolone class herbicide applied at an application rate of 0.5-100 g ai/h, preferably at a rate of 1-50 g ai/h; and/or
(j) the uracil class herbicide applied at an application rate of 10-150 g ai/h, preferably at a rate of 20-70 g ai/h.

11. The method as claimed in claim 1, wherein the synergistic combination comprises glufosinate; an imidazolinone class herbicide, and a triazolone class herbicide.

12. The method as claimed in claim 11, wherein the imidazolinone class herbicide is imazethapyr, and wherein the triazolone class herbicide is carfentrazone.

13. The method as claimed in claim 11, wherein the imidazolinone class herbicide, and the triazolone class herbicide are present in a ratio of 1:100 to 100:1, more preferably 1:10 to 10:1.

14. The method as claimed in claim 1, wherein the method comprises
i. preparing a premix or tank-mix of the glufosinate and the atleast one herbicide; and
ii. applying the prepared premix or tank-mix at the desired locus.

15. The method as claimed in claim 1, wherein the method comprises applying in immediate succession glufosinate and the at least one herbicide.
